(19) United States
(12) Patent Application Publication
(10) Pub. No.: US 2017/0042182 A1
(43) Pub. Date: Feb. 16, 2017

(54) LIQUID COMPOSITION FOR FROZEN CONFECTION, METHOD OF PRODUCTION AND PROCESS OF PREPARATION

(71) Applicant: NESTEC S.A., Vevey (CH)

(72) Inventors: Paola Olmos, Mariel (FR); Charles-Austin Sunderland, Laversines (FR); Andre Noth, Pully (CH)

(73) Assignee: NESTEC S.A., Vevey (CH)

(21) Appl. No.: 15/305,821

(22) PCT Filed: May 6, 2015
(86) PCT No.: PCT/EP15/60002

§ 371 Date: Oct. 21, 2016

(30) Foreign Application Priority Data
May 7, 2014 (EP) 14167326.9

(51) Int. Cl. A23G 9/40; A23G 9/04; A23G 9/42; A23L 3/16

(52) U.S. Cl. CPC A23G 9/40; A23L 3/16; A23G 9/045; A23G 9/42; A23V 2002/00

(57) ABSTRACT

The present invention relates a liquid composition for frozen confection, in particular to a shelf stable composition which is suitable for making freshly prepared frozen confection. The liquid composition for frozen confection comprising 0.01 to 2% whey protein by weight based on the total composition (wt.); 0.01 to 3% wt of stabilizers, below 4.5% wt of fat, below 15% wt of sweetener, at least 25 % wt fruit, and having pH in the range from 3.5 to 4.2, preferably in the range of from 3.6 to 3.8 and solid content above 10% wt. The invention also relates to a method of production of the liquid composition and to a method of preparation of the frozen composition.

### FIELD OF THE INVENTION

The present invention relates a liquid composition for frozen confection, in particular to a shelf stable composition which is suitable for making freshly prepared frozen confection. The invention also relates to a method of production of the liquid composition and to a method of preparation of the frozen composition.

### BACKGROUND

Currently, the majority of ice cream consumption at home concerns products bought frozen at the point of sales. There are several drawbacks such as the need to transport the products at home rapidly in order to keep them at the frozen state, the need to store them in a freezer and the limited number of flavors available considering standard freezer volume. Additionally, the texture of such product is rather hard and far from the freshly made ice cream.

An alternative solution available today is the use of an ice cream machine to produce fresh ice cream. Although the obtained texture of the resulting product is more satisfactory the products can be made to have better texture nevertheless drawback exists in term of such products' nutritional profile e.g. high sugar or high fat content in the product compositions.

Classical sorbets are made from sorbet mixes which have crystallized texture and cold mouth feel. These products do not have the creamy sensation of an ice cream experience which some consumers prefer.

Sterilised ambient mixes for sorbets are available for artisanal Gelaterias. These products do not contain fruit pieces, and fruits are normally added in afterward or put on as decoration. These kinds of products are very acid and are not sterilized but can be stored at ambient temperature due to their acidity. This is the case for example of water ice lollies sold at ambient temperature to be frozen at home. Sterilisations of such products with ultra-high temperature treatments (UHT) are not done because the high temperature applied are known to discolour the fruit and provide off taste to the product.

It is well known in the art that products that have the right combination of low pH, adequate levels of acetic acid, salt and sugars can be filled into package without a thermal process and still be safe and stable. The New South Wales (NSW) food authority NSW/FA/FI035/0811 defines acidified foods to mean low acid foods to which acid(s) or acid food(s) are added. These foods have a finished equilibrium pH of 4.6 or below.

Heat treatment with acid is a classical method of denaturing proteins. It is known from literature that doing protein modification could improve food product sensory properties, in particular creaminess, as well as foaming.

WO2012016852 describes a method to produce shelf-stable frozen confectionery products comprising caseins which are suitable for quiescent freezing to form frozen confectionery products. In particular, the invention is concerned with unfrozen packaged confections comprising a coagulated protein system which contributes to the stability of the confections in particular when stored at room or chilled temperatures. This is achieved by adding PGMS as an emulsifier, subjecting a composition comprising dairy proteins with a high pH between 5.6 and 6.5 to a heat treatment at 80-90° C. or above 90° C. up to 160° C., for a time period of 1 second to 60 minutes. WO2012016852 relates to dairy based compositions where pH is usually not lower than 5.6.

High acidification of protein containing compositions (and also UHT treatment) usually both lead to an issue with protein coagulation with a negative impact on texture with smoothness reduction due to granulation.

In addition to the above consumers' demand continuously increases for “better for you” types of products with lower fat contents or even non-fat products, while not compromising on taste.

In view of the previous discussion, there is therefore a need to find solution to provide shelf stable liquid compositions for freshly prepared ice cream which provides good texture and taste and a good nutritional profile.

### OBJECT OF THE INVENTION

It is thus the object of the present invention is to provide liquid composition for preparation of frozen confection, in particular for freshly made frozen confection, which has a creamy texture and which has a good nutritional profile.

### SUMMARY OF THE INVENTION

It was surprisingly found that a liquid composition for preparation of a frozen confection can be made although the proteins in the composition have been exposed to acid coagulation, at low pH, and combined with UHT treatment which is known to increases the coagulation rate. In has also been found that when freezing the liquid composition while stirring it is possible to obtain a creamy texture even with a low fat recipe.

Accordingly, the present invention relates to a liquid composition for frozen confection comprising
0.01 to 2% whey protein by weight based on the total composition (wt.)
0.01 to 3% wt of stabilizers
below 4.5% wt of fat,
below 15% wt of sweetener,
at least 25% wt fruit, and
   having pH in the range from 3.5 to 4.2, preferably in the range of from 3.6 to 3.8 and solid content above 10% wt.

In particular the invention relates to a liquid composition which has been subjected to ultra-high temperature treatment, and which is shelf stable. It has surprisingly been found that the UHT treatment on such acid liquid composition a positive effect on texture of the product was obtained.

A particular advantage of the invention is that it allows the making of a frozen confection with improved sensorial properties of low fat and low sugars formulations, for example when the fat content of the product is below 4% wt. Even a fat content below 2% fat this advantage is detected for the creamy texture, the increased mouth coating and body similar to full fat products. Preferably the liquid product comprises below 1% fat, more preferably below 0.5% fat. At this low level the advantage is present as illustrated in the examples. When the product contains low sugar, such as below 10% wt of added sugars or even below 7% wt the advantage is that even with the modification of freezing point, the use of the high velocity stirring means allow to obtain soft textures similar to classical ice creams but without the inconvenience of the level of sugars for the health as the classical products.

Sterilization of milk based products is normally performed close to neutral pH to avoid thermal casein denaturation. However, in the case of the present invention, it would not have been possible to make fruits containing products in such a pH range (between 6.6 and 7.0) as it would have damaged the fruity colour due to its antocians content.

It was found that a more acidic pH was needed in order to preserve the natural colour and acid taste of the fruit. Therefore, in the present invention, the pH is much lower (from 3.6 to 3.8) and the heat treatment applied is much higher and it would have rather been anticipated to have very negative impact on the protein coagulation and therefore on texture but surprisingly the effect was a stable liquid product.

In a further aspect, the invention relates to a method of production a liquid frozen confection product, comprising the steps of:
a) providing an liquid composition according to claims 1 to 8,
b) homogenizing the composition,
c) heating the composition at a temperature of at least 90° C., preferably at least 130° C. for a period of at least 30 sec; and
d) packaging the liquid composition.

The product obtained is shelf stable.

In an additional aspect, the invention relates to a process for preparation of a frozen confection, comprising the steps of
a) providing a liquid composition according to claims 1 to 10,
b) freezing the liquid composition by cooling it for a period below 10 minutes to a temperature below 0° C., preferably to a temperature in the range from −2 to −10° C., and at the same time
c) aerating the liquid composition to an overrun in the range from 30% to 120% by stirring the composition.

### BRIEF DESCRIPTION OF THE FIGURE

FIG. 1 shows a sorbet made with 70% overrun.

FIG. 2 shows a product according to the invention made with 100% overrun.

FIG. 3 shows the transformation of the textural properties of the products during freezing/whipping process according to the invention

FIG. 4 shows the freezing rate and overrun evolution of the confection during the process.

### DETAILED DESCRIPTION OF THE INVENTION

According to the present invention a liquid composition is provided which provides a frozen confectionery product which contains below 2% fat while as still taste as indulgent as full fat ice cream.

By a shelf stable is meant products that do not spoil under ordinary unrefrigerated temperature and humidity conditions, if the package integrity is maintained. These products are free of microorganisms capable of growing in or on the product at non-refrigerated conditions at which the product is held during distribution and storage Food Safety and Inspection Service-United States Department of Agriculture (FSIS USDA 2005).

In the present content ultra-high temperature treatment (UHT) is temperature treatment wherein the product is subjected strong heating for a short time. For the present invention it is preferred that the liquid product is subjected to a heat treatment with a temperature of at least 90° C., preferably at least 130° C. for a period of at least 30 sec. A preferred time of treatment is from 30 sec to 3 min. The invention also relates to a liquid product which has been heat treated at a temperature in the range from 90° C. to 160° C.

Further in the present context substantially free from caseins means that the product might comprises traces of casein, less than 0.01% coming tentatively from whey production but not due to intentionally addition of caseins.

Further in the present context unless otherwise indicated % of a component means the % of weight based on the weight of the creamer composition, i.e. weight/weight %.

Further in the present context unless otherwise indicated the ranges indicated in this application includes the end points.

Protein aggregation has normally been perceived negatively, but it was surprisingly discovered that frozen confectionery product with controlled protein aggregation had an improved creamy texture than other products. This is thought to be due to an increased viscosity and increased interfacial properties which results in the foaming properties being more pronounced.

The confection product according to the present invention comprises one or more types of proteins. The proteins may be selected from any dairy protein and fruit and vegetable protein.

In a preferred embodiment of the present invention, the protein is a dairy protein. The protein may also be a fruit or vegetable protein in general.

The proteins present in the ingredient mix to prepare the frozen confection product according to the present invention are partially coagulated due to acids naturally present on the fruit puree. This coagulation is induced by the presence of acids from natural fruit puree combined with a heat treatment.

Preferably, the proteins are dairy proteins which are usually present in an ice cream mix and which comprises whey proteins. Such proteins may undergo partial coagulation.

In the present context the whey protein means the actual protein in the whey source. The whey may be in the form of whey powder or concentrates or isolate. The whey protein also may also be in a liquid form.

According to the invention the whey protein is present in the liquid product in an amount of 0.01 to 2% by weight based on the total composition. Above this amount the liquid product increases its foaming properties to a such point that during whipping/freezing process, the obtained texture is too foamy and typical ice cream texture and creaminess are lost. Below this amount the creaminess of the product is reduces. In a preferred embodiment the liquid product comprises 0.05 to 1.5% of whey protein in this range the product has a surprisingly creamy texture.

Most milk proteins (mainly caseins) in their native state remain in colloidal suspension form leading to minimal changes to mix viscosity (˜200-400 cp). However, when proteins are subjected to controlled exposure to known amounts of heat and acid (e.g., pH of 6.4 or less and pasteurization) they undergo coagulation. Coagulation is a state where the proteins are hydrated resulting in a three dimensional network (soft gel) causing increased mix viscosity (˜199-2400 cp). If the exposure of proteins to heat and acid is not controlled, this phenomenon could lead to precipitation (e.g. syneresis in yoghurt).

In a preferred embodiment according the invention the liquid composition is substantially free of casein. The advantage of this is that at the working pH of the invention (pH from 3.5 to 4.2, preferably from 3.5 to 4.0, more preferably from 3.6 to 3.8). The caseins coagulate in presence of heat. Therefore the absence of casein allows the addition of fruits in acidic media without losing fruit properties in term of color and taste.

In the present context stabilizers can be emulsifiers or hydrocolloids. An emulsifier is a substance that stabilizes an emulsion by increasing its kinetic stability. A hydrocolloid is defined as a colloid system wherein the colloid particles are hydrophilic polymers dispersed in water. A hydrocolloid has colloid particles spread throughout water, and depending on the quantity of water available that can take place in different states, e.g., gel or sol (liquid).

The liquid composition according to the invention comprises 0.01 to 3% wt of stabilizers. The stabilizers are preferably hydrocolloids, in particular hydrocolloids selected from the group consisting of guar gum, locus bean gum, pectine, fibers or combinations thereof.

Another feature of the liquid composition according to the invention is the high fruit content. Preferably the composition comprises at least 25% wt of fruit, more preferably at least 30% wt of fruit. To provide even more healthy products the content of fruit in the liquid composition is from preferably 35 to 70% fruit by weight. The total fruit content is calculated by adding the fruit content of each ingredient, taking into account the degree of concentration in case of fruit juice concentrates.

The contribution to the fruit content may come from one or more ingredients chosen from natural fruit juice, fruit puree, fruit concentrate, fruit pieces or mixtures thereof.

Fruits which have a lower pH can advantageously be used in the liquid composition. Examples of suitable fruits and their pH value are given in table 1. These fruits can be used alone or in combination.

TABLE 1

| Fruit Pure | pH |
|---|---|
| Strawberry | 3.2-3.6 |
| Lemon | 1.6-2.2 |
| Raspberry | 2.7-3.1 |
| Peach | 3.5-4.0 |
| Mango | 3.5-4.0 |
| Blackberry | 3.0-3.6 |
| Blackcurrant | 2.8-3.5 |

In a particular preferred embodiment the liquid composition comprises strawberry in an amount of at least 30%, in particular in the range from 35 to 70% wt.

Depending of the amount and pH of the fruit in the liquid product it may be necessary to adjust the pH to the ranges indicated above. Thus in an embodiment of the invention the liquid product comprises a pH adjusting agent. The pH adjusting agent may for example be molasses, an edible organic acid such as citric acid, acetic acid, lactic acid, malic acid, ascorbic acid, benzoic acid, fumaric acid, lactones such as glucono-delta-lactone, fruit derived acids and fermentation derived acids. In a preferred embodiment of the invention, the liquid product comprises a pH adjusting agent which is citric acid or lemon juice.

According to a specific embodiment of the invention, the product essentially consists of natural ingredients.

The term “essentially consist” means that at least 95% of the ingredients have to be natural, such as at least 97%, preferably at least 98%, even more preferably at least 99%.

The term “natural ingredients” refer in the context of the present invention to ingredients of natural origin. These include ingredients which come directly from the field, animals, etc. or which are the result of a physical or microbiological/enzymatic transformation process. These therefore do not include ingredients which are the result of a chemical modification process.

In another embodiment of the invention, the product is essentially or completely free of any artificial or non-natural emulsifier or stabilizer.

Examples of artificial and non-natural ingredients which are avoided in a particular embodiment of the invention include for example the following emulsifiers; mono- and diglyceride of fatty acids, acid esters of mono- and diglycerides of fatty acids such as acetic, lactic, citric, tartaric, mono- and diacetyl tartaric acid esters of mono- and diglycerides of fatty acids, mixed acetic and tartaric acid esters of mono- and diglycerides of fatty acid, sucrose esters of fatty acids, polyglycerol esters if fatty acids, polyglycerol polyricinoleate, polyethylene sorbitan mono-oleate, polysorbate 80 and, chemically extracted lecithins.

The term “artificial emulsifiers” may also be referred to as synthetic emulsifiers or non-natural emulsifiers and the terms may be used interchangeably.

Chemically modified starches which are used in the art as stabilizers are also preferably avoided. These include for example modified starch, monostarch phosphate, distarch phosphate, phosphate or acetylated distarch phosphate, acetylated starch, acetylated distarch afipate, hydroxyl propyl starch, hydroxypropyl distarch phosphate, acetylated modified starch.

The products of the present invention are preferably essentially free of the preceding synthetic esters and modified starches.

“Essentially free” means in the context of the present application, that these material are not intentionally added for their conventional property imparting abilities, e.g. stabilizing, although there could be unintended minor amounts present without detracting from the performance of the products. Generally and preferably, the products of the invention will not contain any non-natural materials. By the term “essentially or completely free” is therefore meant that the product comprise 1% by weight or less of a given compound.

In another embodiment of the invention, the frozen confection product is a low-fat product and comprises at most 2% fat by weight.

In the context of the present invention, the term “fat” should be interpreted broadly and generally relates to one or more triglycerides independent of their melting temperature. The term “fat” comprises both triglycerides that are in liquid form at 25° C., as well as triglycerides that are in solid or semi-solid form at 25° C. Fatty acid triesters of the trihydroxy alcohol glycerol which are present in plant and animal tissues that can occur both as liquid or semi-liquid or solid fat forms. The physical and chemical properties of fats and oils depend on the nature of the fatty acids present. Saturated fatty acids give higher melting fats and represent solid fats, for example lard and butter. Unsaturated fats lower the melting point of fatty acids and fats, e.g. plant oils contain large amounts of unsaturated fatty acids.

The liquid composition of the present invention may further include one or more additional ingredients such as flavors, sweeteners, colorants, acids, setting salts, buffer salts or a combination thereof.

According to the invention the liquid composition comprises 10 to 15% sweetener.

Sweeteners can include, for example, sucrose, fructose, dextrose, maltose, dextrin, levulose, tagatose, galactose, corn syrup solids and other natural or artificial sweeteners. Sugarless sweeteners can include, but are not limited to, sugar alcohols such as maltitol, xylitol, sorbitol, erythritol, mannitol, isomalt, lactitol, hydrogenated starch hydrolysates, and the like, alone or in combination. Usage level of the flavors, sweeteners and colorants will vary greatly and will depend on such factors as potency of the sweetener, desired sweetness of the product, level and type of flavor used and cost considerations. Combinations of sugar and/or sugarless sweeteners may be used.

Preferably the sweetener is carbohydrates and the total carbohydrates content is comprised from below 15%, preferably from 1 to 15, more preferably from 9 to 14 wt.-% based on the total composition.

Advantageously, the sweetener is sucrose or glucose syrup or a combination thereof. In a further preferred embodiment of the invention, the sweetener consists of 8% wt white sugar and optionally 8% wt glucose syrup.

In a preferred embodiment the total solids content is between 10 to 40%, preferably from 12 to 30%, more preferably 15 to 24% based on the weight of the total composition. This give a good texture to the product, with lower solid content the product becomes icy and hard in consistency.

The liquid composition may be packed in a container, preferably in a portion size for individual servings.

The liquid composition according to the invention is preferably produced by a method of production comprising the steps of:
a) providing an liquid composition as described above,
b) homogenizing the composition,
c) heating the composition at a temperature of at least 90° C., preferably at least 130° C. for a period of at least 30 sec, preferably from 30 sec to 3 min; and
d) packaging the liquid composition.

The composition is then shelf stable due to the heat treatment.

The liquid composition may be packed into a container which is preferably a single-use container which provides an initial packaging container for a predefined amount of ingredients. The packaging container preferably contains confectionery ingredients which are stored under ambient conditions and shelf stable for an extensive period of time (e.g., several weeks). Further, the container is also designed for being used as process container, i.e. as container in which the frozen confectionery is prepared, as well as serving container, i.e. as container from which the consumer may directly consume the resulting frozen confectionery. Preferably, the packaging container comprises an identification means containing a recipe code related to the type of cooled product to be prepared. In the preferred mode, the identification means comprises at least one barcode.

The term “single-use container” when used in the present invention encompasses any container suitable for being disposed after being used for the preparation of the single-portion of cooled product. Thereby, the containers are preferably at least partially recyclable.

In one aspect the invention also relates to a process for preparation of a frozen confection, comprising the steps of
a) providing a liquid composition according to the invention as discussed above,
b) freezing the liquid composition by cooling it for a period below 10 minutes to a temperature below 0° C., preferably between −2 and −10° C., and at the same time
c) aerating the liquid composition to an overrun of 30% to 120% by stirring the composition.

A desirable creamy product texture is obtained when the freezing of the product is to a temperature from in the range from −2° C. to −6° C., and an aeration to an overrun in the range from 70% to 110%.

The freezing may be done by means of a conventional domestic ice cream maker. Alternatively and preferably the liquid composition may be prepared by in a machine for preparing frozen confection as disclosed in co-pending patent applications: European patent application number 12190562.4 filed on 30 Oct. 2012; European patent application number 13190868.3 filed 30 Oct. 2013; and European patent application number 13190834.5 filed on 30 Oct. 2013.

The contents of these applications are hereby incorporated by reference.

A process for preparation of a frozen confection with a liquid product as discussed above is preferably done with a process, wherein the aerating is done by means of a stirring member and by contacting the composition during freezing with the stirring member
which stirring means has a planetary movement with an angular velocity ω2 between 30 and 300 rpm and/or a rotation about an axis with an angular velocity ω1 of 1 to 1700 rpm, preferably between 400 and 900 rpm. A particular preferred optimum for the making of frozen confection is with a ω1 between 700 and 900 rpm.

Preferably for this embodiment of the invention the frozen confection is prepared in its container. For this purpose a container is having a heat exchange contact surface through which the product is cooled may conveniently be used. This allows for a quick freezing of the liquid composition when the container is brought into contact with cooling means during the aeration.

Advantageously, the process mentioned above may be performed in a machine for preparing a cooled food product as disclosed in European patent application number 13190868.3 filed 30 Oct. 2013. This machine comprises:
a receiving seat, for accommodating a container, comprising a heat exchange element having a heat exchange contact surface arranged to be in contact with an outer surface of a side wall of the container when the container is placed in the machine,
a cooling unit arranged for cooling the heat exchange element and,
a stirring unit connectable to a stirring member and arranged for driving the stirring member in at least one rotational movement;
wherein it comprises
   means for measuring the temperature of the product while being prepared,
   a control unit for automatically setting output parameters according to input parameters received by the control unit and compared to threshold values stored in the unit;
   wherein the output parameters comprises: at least one rotational velocity of the stirring member and the cooling power of the cooling unit, and
   wherein the input parameters comprises any one or a combination of: the measured product temperature and the stirring time.

The machine preferably has a stirring unit being arranged for driving the stirring member according to a combination of movements, wherein the combination of movement comprises a first rotational movement of the stirring member about its longitudinal axis (Z) which is arranged offset to a central longitudinal axis (X) of the receiving seat (1) and/or of the container and wherein the second rotational movement comprises an orbital rotational movement about the central longitudinal axis (X) of the container or seat (1) and wherein the output parameters comprise the first velocity (ω1) of the first rotational movement and the second velocity (ω2) of the second rotational movement of the stirring member. A machine of the above-mentioned type was used in the examples.

### EXAMPLES

By way of example and not limitation, the following examples are illustrative of various embodiments of the present disclosure.

Water Based Frozen Confection with Similar Mouth Feel to that of Dairy Ice Cream

### Example 1

A water base shelf-stable confectionery product comprising a fruit source, stabilizing system and whey proteins source was prepared based on the following ingredient mix:

| Ingredients | Wt % of final product |
|---|---|
| Strawberry puree, no sugar added | 35 |
| Fat | 0.27 |
| Added Sugar | 11.4 |
| Whey proteins | 0.08 |
| Stabilizers: guar, LBG | 0.30 |
| Total solids | 15.34 |
| FPD (freezing point depression) | −0.78 |
| pH mix before heat treatment | 3.8 |

### Process Conditions

1. Mixing Conditions

All ingredients were mixed at 65° C. and then divided in 2 batches: one was treated by pasteurization and other by sterilization as follows:

| Step | Pasteurization | Sterilization |
|---|---|---|
| Heat treatment | heat plate exchanger at | heat plate exchanger at |
| | 86° C. 30 sec | 130° C. 30 sec |
| Homogenization | 2 step high pressure | 2 step high pressure |
| | homogenizer at 150 | homogenizer at 150 |
| | and 50 bar | and 50 bar |
| Aging | 24 h at 4° C. | 24 h at 4° C. |

2. Freezing Conditions

Both aged mixes were frozen at −6° C. with a machine for preparing frozen confection of the type that is discussed above.

### Results

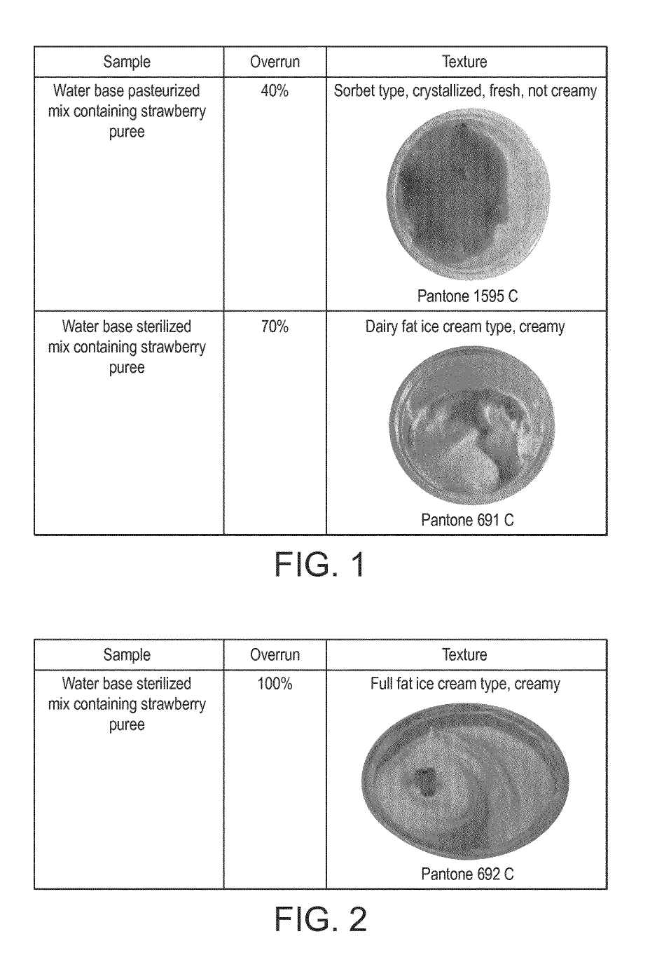

The sterilized water base shelf-stable confectionery product when frozen with home machine surprisingly delivered a product similar to dairy fat ice cream because of its creaminess in mouth, and appearance. The mix that was treated with less heat and which was frozen following the same procedure, resulted in a standard sorbet type of product. The resulting products are shown in FIG. 1.

FIG. 1 shows the sorbet type product according to the invention made with a machine for preparing frozen confections with 70% overrun, and the results of experiment 1 where it can be seen that for a given recipe containing 35% strawberry puree and 0.2% whey proteins, the overrun was increased from 40% to 70% during freezing/whipping when sterilization process was applied in the mix.

### Example 2

A water base shelf-stable confectionery product comprising a fruit source, stabilizing system and whey proteins source was prepared based on the following ingredient mix:

| Ingredients | Wt % of final product |
|---|---|
| Strawberry puree, no sugar added | 50 |
| Fat | 0.27 |
| Added Sugar | 11.4 |
| Whey proteins | 1.14 |
| Stabilizers: guar, LBG | 0.30 |
| Total solids | 23.40 |
| FPD | −1.11 |
| pH mix before heat treatment | 3.6 |

### Process Conditions

1. Mixing Conditions

All ingredients were mixed at 65° C. and then treated using UHT as described in the previous example 1.

2. Freezing Conditions

Both aged mixes were frozen with a machine for preparing frozen confection as disclosed in co-pending patent applications mentioned above at −6° C.

### Results

It was observed that reducing the pH to 3.6 by increasing the source of fruit, and at the same time, increase whey proteins content surprisingly does not lead to protein flocculation at sterilization conditions. Instead of that, the foaming property of the recipe was increased and texture was even closer to full fat ice cream type of texture.

The resulting product is shown in FIG. 2 where it can be seen that for a given sterilized confection containing 50% strawberry puree and 1.14% whey proteins, the overrun obtained was about 100% during freezing/whipping process and the appearance of the obtained product was closer to a full fat ice cream.

### Example 3

### Process

### Fruit Rich Product

Pour 70 g to 90 g of prepared mix that has been stored at chilled (+4° C.) or ambient temperature (20° C.) into a cup with a volume between 150 ml to 250 ml.

To maximise heat transfer through the cup it is preferable that it should be, at least in part, metallic for example aluminium. The cup is placed into the preparation system so that its sides are in contact with the cooling surface.

A stirrer is then inserted into the preparation system. The form of the stirrer is adapted to incorporate air into the product and to move colder product from the cups walls that are in contact with the cooling surface towards the centre of the cup to better equalise product temperature. For example it could be a whisk type. In this example it is more spatula like with a form that follows the contours of the cup.

Traditional kitchen bench top ice cream machines use stirrers that turn speeds ranging from 28 rpm to 72 rpm generally around a single central axis.

The stirring action has in this example two mixing axis, one around the axis of the stirrer its self and the second a planetary movement that permits the stirrer to move through the entire contents of the cup. The planetary movement and that of the stirrer can be in either a clockwise or anticlockwise direction. The speed of the planetary movement can vary between 30 to 300 rpm and the stirrer turns on its axis in at speeds from 1 to 1700 rpm. In this example the planetary movement is 60 rpm in a clockwise direction and the stirrer turns on its axis at 800 rpm in a clockwise direction

In the preparation system the mixture described in the examples 1 and 2 above is cooled and stirred. The stirring action incorporates air into the mixture as it cools. The liquid product is transformed into frozen dessert such as an ice cream type product at a temperature below 0° C. preferably between −2° C. to −6° C. As mixing time increases more air is incorporated into the preparation to give products with an overrun from 40% to over 100%. In this example at the end of mixing the product has 87% over run and a temperature of −4.7° C.

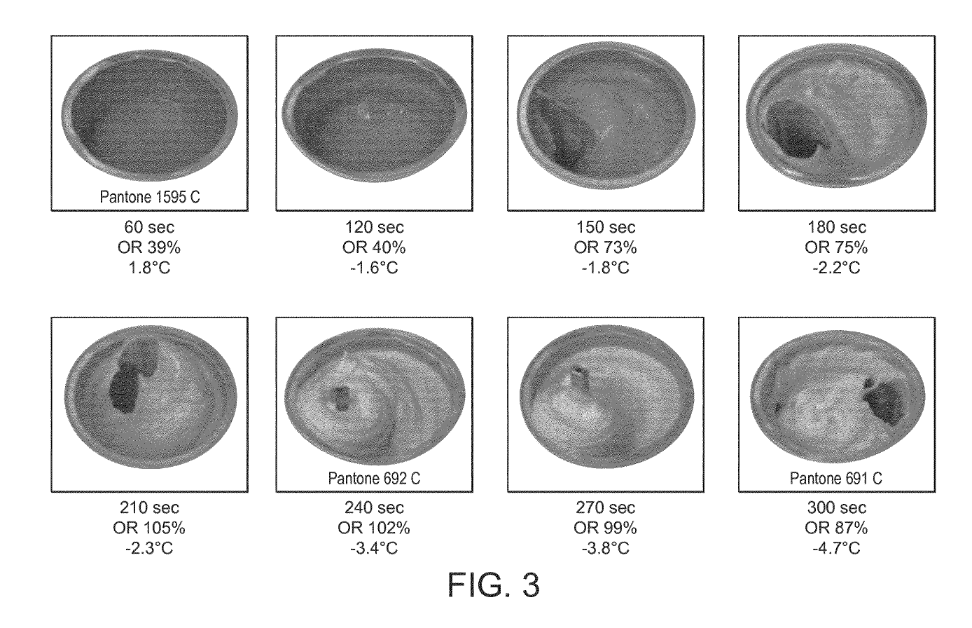

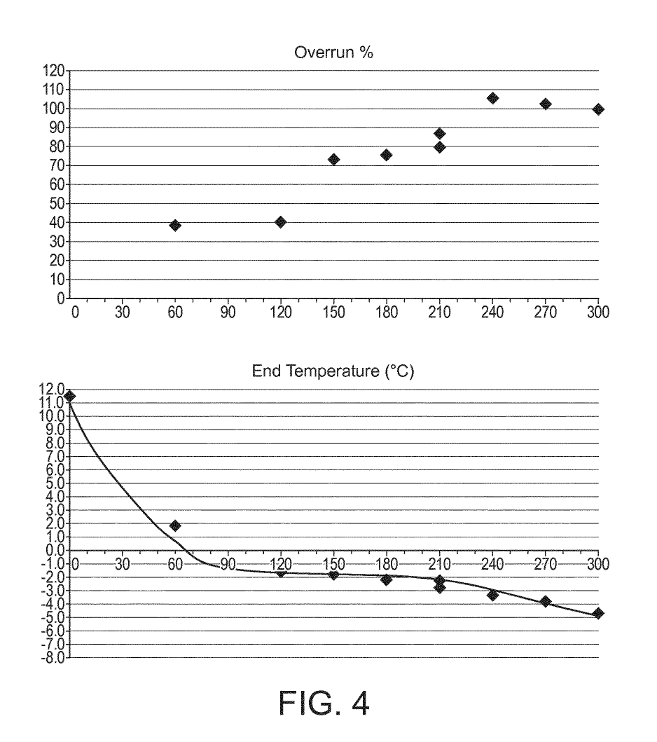

FIG. 3 shows product obtained from the preparation system using the same recipe outlined in example 1 above:—
1. Smooth drinkable product at −1.6° C. with 40% overrun (first photo)
2. Spoonable smooth creamy texture frozen fruit rich dessert at −4.7° C. with 87% overrun (last photo).

FIG. 4 shows graphs of:—
1. Cooling curve of recipe during its preparation in the system
2. Evolution of overrun achieved in recipe 1 during its preparation in the system

### Example 4

A water base shelf-stable confectionery product comprising a fruit source, stabilizing system and whey proteins source was prepared based on the following ingredient mix:

| Ingredients | Wt % of final product |
|---|---|
| Strawberry puree, no sugar added | 35 |
| Fat | 0.27 |
| Added Sugar | 11.4 |
| Whey proteins | 0.08 |
| Stabilizers: guar, LBG | 0.30 |
| Total solids | 15.34 |
| FPD (freezing point depression) | −0.78 |
| pH mix before heat treatment | 3.8 |

Process Conditions

1. Mixing Conditions

All ingredients were mixed at 65° C. and then divided in 2 batches: one was treated by pasteurization and other by sterilization as follows:

| Step | Pasteurization | Sterilization |
|---|---|---|
| Heat treatment | heat plate exchanger at | heat plate exchanger at |
| | 86° C. 30 sec | 130° C. 30 sec |
| Homogenization | 2 step high pressure | 2 step high pressure |
| | homogenizer at 150 | homogenizer at 150 |
| | and 50 bar | and 50 bar |
| Aging | 24 h at 4° C. | 24 h at 4° C. |

2. Freezing Conditions

Both aged mixes were frozen with a home sorbet maker available on the market (Magimix Gelato 2000) at 80 rpm for 30 min and −6° C.

### Results

Both mixes, pasteurized and sterilized delivered a sorbet type of product when they were frozen in standard home machine at around −6° C. but surprisingly the frozen sterilized mix was creamier in comparison with the frozen pasteurized mix. The overrun obtained was slightly increased in the case of sterilized mix (35% pasteurized, 45% sterilized)

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A liquid composition for frozen confection comprising:
0.01 to 2% whey protein by weight based on the total composition (wt.);
0.01 to 3% wt of stabilizers;
less than 4.5% wt of fat;
less than 15% wt of sweetener;
at least 25% wt fruit; and
having pH in the range from 3.5 to 4.2 and solid content above 10% wt.

2. A liquid composition according to claim 1, wherein the product is substantially free of casein.

3. A liquid composition according to claim 1, wherein the liquid composition comprises from 35 to 70% fruit by weight.

4. A liquid composition according to claim 1, wherein the fruit is in a form selected from the group consisting of fruit pieces, juice, puree, concentrate and combinations thereof.

5. A liquid composition according to claim 1, wherein the sweetener is a carbohydrate and the total carbohydrates content is less than 15% wt based on the total composition.

6. A liquid composition according to claim 1, having a total solids content between 10 to 40% based on the weight of the total composition.

7. A liquid composition according to claim 1, wherein the fat content is less than 1% wt.

8. A liquid composition according to claim 1, wherein the liquid composition has been subjected to a temperature treatment with a temperature in the range from 90° C. to 160° C.

9. A liquid composition according to claim 1, wherein the composition is packed in a container.

10. A method of production a shelf stable liquid confection for preparation of frozen product, comprising the steps of:
a) providing a liquid composition for frozen confection comprising: 0.01 to 2% whey protein by weight based on the total composition (wt.); 0.01 to 3% wt of stabilizers; less than 4.5% wt of fat; less than 15% wt of sweetener; at least 25% wt fruit; and having pH in the range from 3.5 to 4.2 and solid content above 10% wt;
b) homogenizing the composition;
c) heating the composition at a temperature of at least 90° C. for a period of at least 30 sec; and
d) packaging the liquid composition.

11. A process for preparation of a frozen confection, comprising the steps of:
a) providing a liquid composition for frozen confection comprising: 0.01 to 2% whey protein by weight based on the total composition (wt.); 0.01 to 3% wt of stabilizers; less than 4.5% wt of fat; less than 15% wt of sweetener; at least 25% wt fruit; and having pH in the range from 3.5 to 4.2 and solid content above 10% wt;
b) freezing the liquid composition by cooling it for a period below 10 minutes to a temperature below 0° C. and at the same time; and
c) aerating the liquid composition to an overrun in the range from 30% to 120% by stirring the composition.

12. A process for preparation of a frozen confection according to claim 11, wherein the freezing of the product is to a temperature from in the range from −2° C. to −6° C., and an aeration to an overrun in the range from 70% to 110%.

13. A process for preparation of a frozen confection according to claim 11, wherein the aerating is done by means of a stirring member and by contacting the composition during freezing with the stirring member:
which stirring means has a planetary movement with an angular velocity ω2 between 30 and 300 rpm; and/or
a rotation about an axis with an angular velocity ω1 of 1 to 1700 rpm, preferably between 400 and 900 rpm.

14. A process for preparation of a frozen confection according to claim 11, wherein the product is prepared in its container.

15. A process for preparation of a frozen confection according to claim 14, wherein the container is having a heat exchange contact surface through which the product is cooled.
